(19) United States
(12) Patent Application Publication
(10) Pub. No.: US 2026/0255221 A1
(43) Pub. Date: Aug. 27, 2026

(54) APPARATUS, METHOD, AND COMPUTER PROGRAM

(71) Applicant: Nokia Technologies Oy, Espoo (FI)

(72) Inventors: Hua CHAO, Shanghai (CN); Yong Gang WANG, Shanghai (CN); Devaki CHANDRAMOULI, Plano, TX (US)

(73) Assignee: Nokia Technologies Oy, Espoo (FI)

(21) Appl. No.: 19/160,132

(22) PCT Filed: Feb. 27, 2023
(86) PCT No.: PCT/CN2023/078506

§ 371 Date: Aug. 27, 2025

(51) Int. Cl. H04W 28/22; H04L 47/283; H04W 24/10

(52) U.S. Cl. CPC H04W 28/22; H04L 47/283; H04W 24/10

(57) ABSTRACT

The disclosure relates to an apparatus configured to: determine (700) at least one of an uplink packet delay budget and a downlink packet delay budget; receive (702), from a core network function, statistics data for at least one of an uplink packet delay or a downlink packet delay; and adjust (704) at least one of the uplink packet delay budget or the downlink packet delay budget based on the statistics data.

### FIELD OF THE DISCLOSURE

The present disclosure relates to an apparatus, a method, and a computer program for adjusting at least one of an uplink packet data budget or a downlink packet data budget in a communication system.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided an apparatus comprising at least one processor and at least one memory storing instructions that, when executed by the at least one processor, cause the apparatus at least to: determine at least one of an uplink packet delay budget and a downlink packet delay budget; receive, from a core network function, statistics data for at least one of an uplink packet delay or a downlink packet delay; and adjust at least one of the uplink packet delay budget or the downlink packet delay budget based on the statistics data.

The statistics data for at least one of an uplink packet delay or a downlink packet delay may comprise a distribution for at least one of an uplink packet delay or a downlink packet delay.

The statistics data for at least one of an uplink packet delay or a downlink packet delay may comprise at least one of an average or a standard deviation.

The at least one processor and at least one memory may store instructions that, when executed by the at least one processor, cause the apparatus at least to: adjust at least one of the uplink packet delay budget or the downlink packet delay budget based on a round trip latency requirement.

The statistics data and the round trip latency requirement may be specific for a certain quality of service flow.

The at least one processor and at least one memory may store instructions that, when executed by the at least one processor, cause the apparatus at least to: adjust at least one of the uplink packet delay budget or the downlink packet delay budget so that the uplink packet delay limited by the uplink packet delay budget plus the downlink packet delay limited by the downlink packet delay budget is lower than or equal to the round trip latency requirement.

The at least one processor and at least one memory may store instructions that, when executed by the at least one processor, cause the apparatus at least to: send, to a core network function, an indication indicating to determine statistics data.

The at least one processor and at least one memory may store instructions that, when executed by the at least one processor, cause the apparatus at least to: send, to a core network function, an indication indicating at least one parameter to determine the statistics data.

The at least one parameter may comprise an indication of a first time interval, an indication of a second time interval or an indication indicating the statistics data to be determined.

The at least one processor and at least one memory may store instructions that, when executed by the at least one processor, cause the apparatus at least to: send, to the core network function, at least one of the indication indicating to determine statistics data or the indication indicating at least one parameter to determine the statistics data in response to a request, from another core network function, to obtain statistics data.

According to an aspect there is provided an apparatus comprising means for: determining at least one of an uplink packet delay budget and a downlink packet delay budget; receiving, from a core network function, statistics data for at least one of an uplink packet delay or a downlink packet delay; and adjusting at least one of the uplink packet delay budget or the downlink packet delay budget based on the statistics data.

According to an aspect there is provided an apparatus comprising circuitry configured to: determine at least one of an uplink packet delay budget and a downlink packet delay budget; receive, from a core network function, statistics data for at least one of an uplink packet delay or a downlink packet delay; and adjust at least one of the uplink packet delay budget or the downlink packet delay budget based on the statistics data.

According to an aspect there is provided a method comprising: determining at least one of an uplink packet delay budget and a downlink packet delay budget; receiving, from a core network function, statistics data for at least one of an uplink packet delay or a downlink packet delay; and adjusting at least one of the uplink packet delay budget or the downlink packet delay budget based on the statistics data.

According to an aspect there is provided a computer program comprising computer executable code which when run on at least one processor is configured to: determine at least one of an uplink packet delay budget and a downlink packet delay budget; receive, from a core network function, statistics data for at least one of an uplink packet delay or a downlink packet delay; and adjust at least one of the uplink packet delay budget or the downlink packet delay budget based on the statistics data.

According to an aspect there is provided an apparatus comprising at least one processor and at least one memory storing instructions that, when executed by the at least one processor, cause the apparatus at least to: receive, from a radio access network node, first statistics data for at least one of an uplink packet delay or a downlink packet delay; determine second statistics data for at least one of the uplink packet delay or the downlink packet delay based on the first statistics data; and send, to a core network function, the second statistics data.

The first statistics data may comprise a distribution for at least one of a radio access network part of the uplink packet delay or a radio access network part of the downlink packet delay.

The first statistics data may comprise at least one of an average and a standard deviation.

The at least one processor and at least one memory may store instructions that, when executed by the at least one processor, cause the apparatus at least to: determine at least one of a core network part of the uplink packet delay and a core network part of the downlink packet delay; and determine the second statistics data based on at least one of the core network part of the uplink packet delay or the core network part of the downlink packet delay.

The second statistics data may comprise a distribution for a sum of the radio access network part and the core network part of the uplink packet delay or a sum of the radio access network part and the core network part of the downlink packet delay.

The second statistics data may comprise at least one of an average and a standard deviation.

The second statistics data may be determined at a first time interval.

The second statistics data may be based on measurements reported at a second time interval.

The second time interval may be different from the first time interval.

According to an aspect there is provided an apparatus comprising means for: receiving, from a radio access network node, first statistics data for at least one of an uplink packet delay or a downlink packet delay; determining second statistics data for at least one of the uplink packet delay or the downlink packet delay based on the first statistics data; and sending, to a core network function, the second statistics data.

According to an aspect there is provided an apparatus comprising circuitry configured to: receive, from a radio access network node, first statistics data for at least one of an uplink packet delay or a downlink packet delay; determine second statistics data for at least one of the uplink packet delay or the downlink packet delay based on the first statistics data; and send, to a core network function, the second statistics data.

According to an aspect there is provided a method comprising: receiving, from a radio access network node, first statistics data for at least one of an uplink packet delay or a downlink packet delay; determining second statistics data for at least one of the uplink packet delay or the downlink packet delay based on the first statistics data; and sending, to a core network function, the second statistics data.

According to an aspect there is provided a computer program comprising computer executable code which when run on at least one processor is configured to receive, from a radio access network node, first statistics data for at least one of an uplink packet delay or a downlink packet delay; determine second statistics data for at least one of the uplink packet delay or the downlink packet delay based on the first statistics data; and send, to a core network function, the second statistics data.

According to an aspect there is provided an apparatus comprising at least one processor and at least one memory storing instructions that, when executed by the at least one processor, cause the apparatus at least to: determine first statistics data for at least one of an uplink packet delay or a downlink packet delay; and send, to a core network function, the first statistics data.

The at least one processor and at least one memory may store instructions that, when executed by the at least one processor, cause the apparatus at least to: receive, from a core network function, an indication indicating to determine statistics data.

The at least one processor and at least one memory may store instructions that, when executed by the at least one processor, cause the apparatus at least to: receive, from a core network function, an indication indicating at least one parameter to determine the statistics data.

The first statistics data may be determined at a first time interval.

The first statistics data may be based on measurements at a second time interval.

According to an aspect there is provided an apparatus comprising means for: determining first statistics data for at least one of an uplink packet delay or a downlink packet delay; and sending, to a core network function, the first statistics data.

According to an aspect there is provided an apparatus comprising circuitry configured to: determine first statistics data for at least one of an uplink packet delay or a downlink packet delay; and send, to a core network function, the first statistics data.

According to an aspect there is provided a method comprising: determining first statistics data for at least one of an uplink packet delay or a downlink packet delay; and sending, to a core network function, the first statistics data.

According to an aspect there is provided a computer program comprising computer executable code which when run on at least one processor is configured to: determine first statistics data for at least one of an uplink packet delay or a downlink packet delay; and send, to a core network function, the first statistics data.

According to an aspect there is provided an apparatus comprising at least one processor and at least one memory storing instructions that, when executed by the at least one processor, cause the apparatus at least to: receive, from a core network function, an indication indicating to determine statistics data; and send, to a radio access network node, the indication indicating to determine statistics data.

The at least one processor and at least one memory may store instructions that, when executed by the at least one processor, cause the apparatus at least to: receive, from the core network function, an indication indicating at least one parameter to determine the statistics data; and send, to the radio access network node, the indication indicating at least one parameter to determine the statistics data. The at least one processor and at least one memory may store instructions that, when executed by the at least one processor, cause the apparatus at least to: receive, from the core network function, the statistics data; and send, to another core network function, the statistics data.

According to an aspect there is provided an apparatus comprising means for: receiving, from a core network function, an indication indicating to determine statistics data; and sending, to a radio access network node, the indication indicating to determine statistics data.

According to an aspect there is provided an apparatus comprising circuitry configured to: receive, from a core network function, an indication indicating to determine statistics data; and send, to a radio access network node, the indication indicating to determine statistics data.

According to an aspect there is provided a method comprising: receiving, from a core network function, an indication indicating to determine statistics data; and sending, to a radio access network node, the indication indicating to determine statistics data.

According to an aspect there is provided a computer program comprising computer executable code which when run on at least one processor is configured to: receive, from a core network function, an indication indicating to determine statistics data; and send, to a radio access network node, the indication indicating to determine statistics data.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AMF: Access and Mobility Management Function
API: Application Programming Interface
BS: Base Station
CU: Centralized Unit
DL: Downlink
DU: Distributed Unit
gNB: gNodeB
GSM: Global System for Mobile communication
HSS: Home Subscriber Server
IoT: Internet of Things
KI: Key Issue
LTE: Long Term Evolution
MAC: Medium Access Control
MS: Mobile Station
MTC: Machine Type Communication
NEF: Network Exposure Function
NF: Network Function
NR: New radio
NRF: Network Repository Function
PCC: Police and Charging Control
PDCP: Packet Data Convergence Protocol
PDU: Packet Data Unit
PSA: PDU Session Anchor
QoS: Quality of Service
RAM: Random Access Memory
RAN: Radio Access Network
ROM: Read Only Memory
RLC: Radio Link Control
RT: Round Trip
SMF: Session Management Function
TR: Technical Report
TS: Technical Specification
TSC: Time Sensitive Communications
UE: User Equipment
UMTS: Universal Mobile Telecommunication System
VR: Virtual Reality
XR: Extended Reality
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a user equipment;

FIG. 4 shows a schematic representation of a quality of service reporting frequency and a statistics window;

FIG. 5 shows a schematic representation of an uplink packet delay budget and a downlink packet delay budget adjusted based on statistics data;

FIG. 6 shows a signaling diagram of a process for adjusting both an uplink packet delay budget and a downlink packet delay budget;

FIG. 7 shows a block diagram of a method for adjusting at least one of an uplink packet delay budget or a downlink packet delay budget performed by an apparatus, for example a policy control function;

FIG. 8 shows a block diagram of a method for adjusting at least one of an uplink packet delay budget or a downlink packet delay budget performed by an apparatus, for example a user plane function;

FIG. 9 shows a block diagram of a method for adjusting at least one of an uplink packet delay budget or a downlink packet delay budget performed by an apparatus, for example a radio access network node;

FIG. 10 shows a block diagram of a method for adjusting at least one of an uplink packet delay budget or a downlink packet delay budget performed by an apparatus, for example a session management function; and

FIG. 11 shows a schematic representation of a non-volatile memory medium storing instructions which when executed by a processor allow a processor to perform one or more of the steps of the methods of FIGS. 7 to 10.

### DETAILED DESCRIPTION OF THE FIGURES

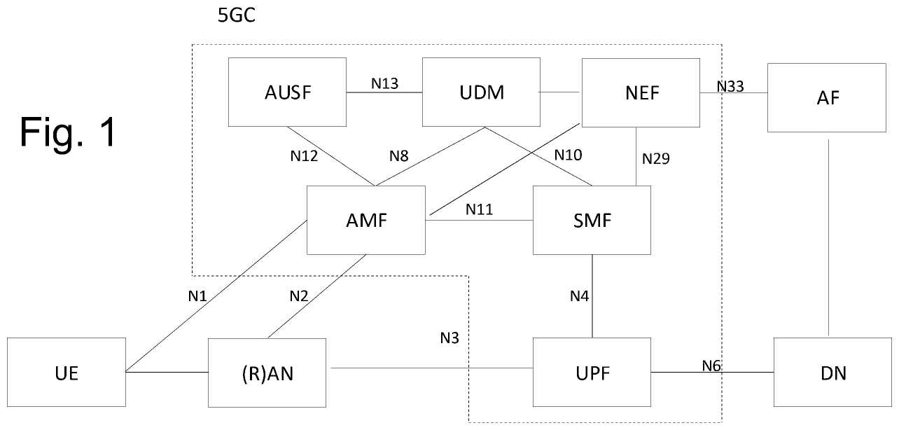

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a user equipment (UE), a radio access network (RAN), a 5G core network (5GC), one or more application functions (AF) and one or more data networks (DN). The RAN may comprise one or more gNodeB (gNB) distributed unit functions connected to one or more gNodeB (gNB) centralized unit functions.

In this disclosure the expressions RAN, 5G RAN and NG RAN may be interchangeable.

The 5GC may comprise an access and mobility management function (AMF), a session management function (SMF), an authentication server function (AUSF), a user data management (UDM), a user plane function (UPF) and/or a network exposure function (NEF).

In this disclosure the expressions user plane function (UPF), PDU session anchor (PSA) or PSA UPF may be interchangeable.

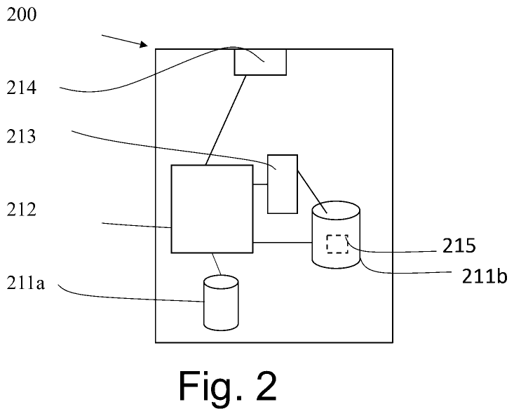

FIG. 2 illustrates an example of a control apparatus 200 for controlling a function of the RAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G RAN or the 5GC. In some embodiments, each function of the RAN or the 5GC comprises a control apparatus 200. In alternative embodiments, two or more functions of the RAN or the 5GC may share a control apparatus.

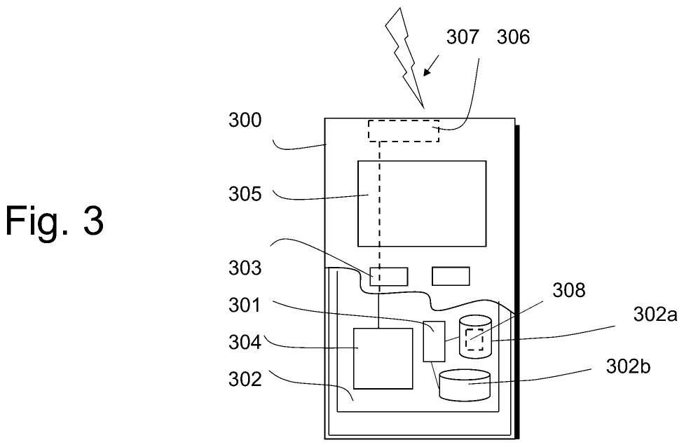

FIG. 3 illustrates an example of a UE 300, such as the UE illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Advanced media services including cloud augmented reality (AR) services, cloud virtual reality (VR) services, cloud extended reality (XR) services, cloud gaming services or video-based tele-control services for machines or drones are expected to increase traffic in a 5GS. These advanced media services, despite of using different codec, have common characteristics (e.g. high throughput, low latency or high reliability requirement. To support these common characteristics, these advanced media services may reuse a current 5GS generic time sensitive communications (TSC) and exposure framework.

SP-211646 ‘New SID on Study on architecture enhancement for XR and media services, SA#94e’ was approved in Rel-18 to investigate enhancements of quality of service (QOS) mechanisms considering the characteristics of these advanced media services and reads as follows.
“The study item aims at identify the system architecture aspects related to better support advanced media services, e.g., High Data Rate Low Latency (HDRLL) services, AR/VR/XR services, and tactile/multi-modality communication services”

TR 23.700-60 ‘Study on XR (Extended Reality) and media services’ defines key issues (KI) and reads as follows.
“KI #6: UL/DL transmission coordination to meet the RT (Round-Trip) latency requirements
   In order to provide immersive experience for users, the XR/media services with real-time interaction typically require very low RT latency. During the RT transmission for XR/media traffic, the challenge is how to meet the very low RT latency requirement with the variable and unbalanced uplink/downlink latency overhead”.

Current conclusions for KI#6 show that the RT latency requirement for a QoS flow may be split into an UL packet delay budget (PDB) for an UL QoS flow and a DL PDB for a DL QOS flow. The UL PDB and DL PDB may be unequal but their sum shall not exceed the RT latency requirement.

The UL PDB may refer to a maximum UL packet delay allowed between the UE and the N6 termination point at the UPF. The DL PDB may refer to a maximum DL packet delay allowed between the N6 termination point at the UPF and the UE.

TS 23.501 defines the QoS monitoring mechanism which is applied for packet delay measurement. The packet delay between UE and UPF is a combination of the RAN part of UL/DL packet delay as defined in TS 38.314 and the 5GC part of the UL/DL packet delay between the RAN and the UPF. The former part is measured and reported by the RAN while the latter part is measured by the PSA UPF.

The UPF may calculate the 5GC part of an UL packet delay and the 5GC part of a DL packet delay. The 5GC part of an UL packet delay and the 5GC part of a DL packet delay may be incurred by the N3 interface between the RAN and the UPF. The UPF may calculate the UL packet delay between a UE and the UPF based on a sum of the received RAN part of the UL packet delay and calculated 5GC part of the UL packet delay. The UPF may calculate the DL packet delay between a UE and the UPF based on a sum of the received RAN part of the DL packet delay and calculated 5GC part of the DL packet delay.

QoS monitoring can be performed by event-triggered or periodic. If periodic method is supplied and the RAN is provided with a parameter called QoS monitoring reporting frequency (e.g. in second). The QoS monitoring reporting frequency may indicate the time interval between successive reports. The RAN may report the measurements of the RAN part of an UL packet delay and the RAN part of a DL packet delay to the PSA UPF at the time interval called QoS monitoring reporting frequency.

In this disclosure the expressions QoS monitoring reporting frequency, QoS monitoring reporting time interval or QoS monitoring reporting period may be used interchangeably.

Based on the QoS monitoring result received from the UPF via the SMF, the PCF may adjust the UL PDB and the DL PDB (e.g. increasing the UL PDB and decreasing the DL PDB or vice versa) whilst still meeting the RT latency requirement. The UL packet delay and the DL packet delay may be unbalanced and/or may vary over time. This may be in particular the case for advanced media services discussed above such as cloud XR/services.

Fixing an UL PDB and a DL PDB may not be optimal. For example, fixing an UL PDB and a DL PDB may not be reflect the variable characteristics of the UL traffic and DL traffic and/or the radio channel conditions.

In light of this, a mechanism for flexibly adjusting an UL PDB and a DL PDB has been proposed.

S2-2208215 ‘KI#6, Overall evaluation and conclusion update’reads as follows.
“The PCF shall also issue two QoS monitoring policies to request monitor UL delay and DL delay respectively. The QoS monitoring is as defined in clause 5.33.3.2 of TS 23.501. Based on the received QoS monitoring result, the PCF adjusts the UL PDB and the DL PDB to better fit the new situation.”

A shortcoming of the above mechanism is that a single value of the RAN part of the UL packet delay and a single value of the RAN part of the DL packet delay are reported by the RAN to the UPF at the time interval called QoS monitoring reporting frequency. The above mechanism does not take into consideration the radio interface jitter and therefore the fact that the RAN part of the UL packet delay and the RAN part of the DL packet delay varies over time. This may lead to unproper adjustment of the UL PDB or the DL PDB and to UL packets or DL packets being lost. For example, if the UL PDB or the DL PDB is too short to cover the radio interface jitter, UL packets or DL packets may be lost.

One or more aspect of this disclosure provides a mechanism for flexibly adjusting an UL PDB and a DL PDB in a more accurate manner.

One or more aspect of this disclosure provides a mechanism wherein the RAN may measure the RAN part of an UL packet delay and the RAN part of a DL packet delay during a time interval, referred to as the statistics window. The statistics window may be different to the QoS monitoring reporting frequency (e.g. in second). The RAN may determine first statistics data for an UL packet delay and a DL packet delay based on the measurements of the RAN part of an UL packet delay and the RAN part of a DL packet delay during the statistics window.

More specifically, the RAN may determine first statistics data for the RAN part of an UL packet delay and the RAN part of a DL packet delay based on the measurements of the RAN part of an UL packet delay and a RAN part of a DL packet delay during the statistics window. The first statistics data may comprise a distribution for the RAN part of an UL packet delay and the RAN part of a DL packet delay. The first statistics data may comprise at least one of an average or a standard deviation.

The statistics window may be shorter, equal or longer than the QoS monitoring reporting frequency and therefore the RAN may measure the first statistics data more frequently than the QoS monitoring reporting frequency, less frequently than the QoS monitoring reporting frequency or as frequently as the QoS monitoring reporting frequency.

It will be understood that in this disclosure the QoS monitoring reporting frequency defines a reporting behaviour but not a measuring behaviour. By contrast, the statistics window defines a measuring behaviour but not a reporting behaviour.

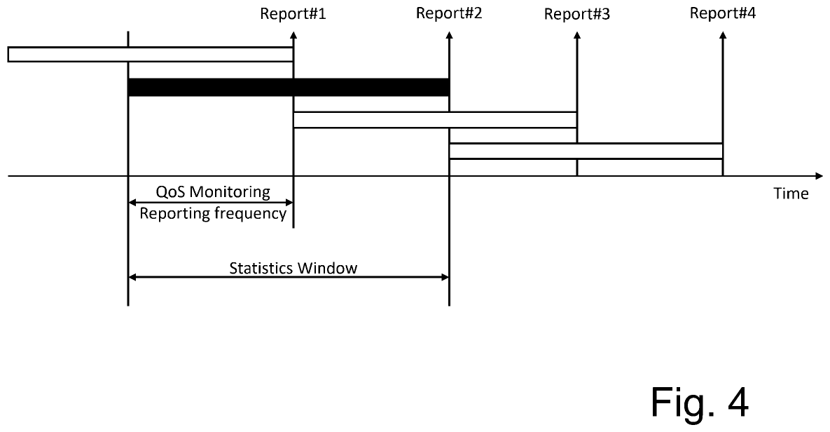

FIG. 4 shows a schematic representation of a QoS monitoring reporting frequency and a statistics window from the RAN perspective. The statistics window may be longer than the QoS monitoring reporting frequency. The statistics window may be a multiple of the QoS monitoring reporting frequency. The statistics window may be limited by the QoS monitoring reporting frequency (e.g. the start of the statistics window may coincide with the start of the QoS monitoring reporting frequency). The statistics window may be a sliding window (e.g. two consecutive statistics windows may be overlapping). However, FIG. 4 is just an example, which shall not be interpreted as any implementation limitations.

The UPF may calculate the 5GC part of an UL packet delay and the 5GC part of a DL packet delay. The 5GC part of an UL packet delay and the 5GC part of a DL packet delay may be incurred by the N3 interface between the RAN and the UPF.

The UPF may use the first statistics data and the calculated 5GC part of an UL packet delay or the 5GC part of a DL packet delay to determine second statistics data for an UL packet delay between a UE and the UPF or a DL packet delay between the UPF and a UE.

More specifically, the UPF may use the first statistics data and the calculated 5GC part of an UL packet delay or the 5GC part of a DL packet delay to determine second statistics data for the sum of the RAN part and the 5GC part of an UL packet delay between a UE and the UPF or the sum of the RAN part and a 5GC part of a DL packet delay between the UPF and a UE. The second statistics data may comprise a distribution for the sum of the RAN part and a 5GC part of an UL packet delay between a UE and the UPF or the sum of the RAN part and the 5GC part of a DL packet delay between the UPF and a UE. The second statistics data may comprise at least one of an average or a standard deviation. The UPF may report the second statistics data to the PCF.

The PCF may use the second statistics data and a RT latency requirement to adjust an UL PDB and a DL PDB.

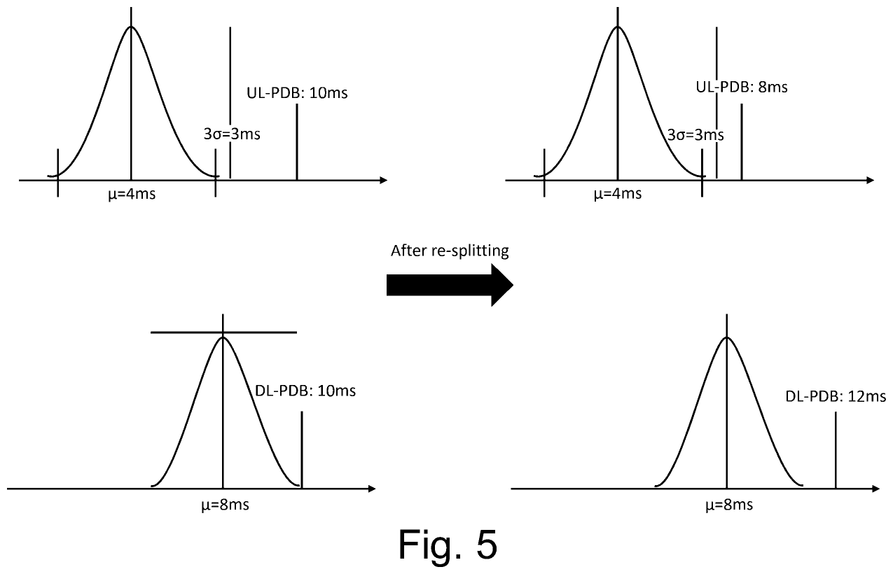

FIG. 5 an UL PDB and a DL PDB adjusted based on second statistics data. Initially, The UL PDB may be 10 ms (top left-hand side). The DL PDB may be 10 ms (bottom left-hand side). The RT latency requirement may be 20 ms.

The UPF may determine the second statistics data for an UL packet delay between a UE and the UPF (top left-hand side). The average may be 4 ms. The standard deviation may be 3 ms.

The UPF may determine the second statistics data for DL packet delay between the UPF and an UE(bottom left-hand side). The average may be 8 ms. The standard deviation may be 2 ms.

The UPF may report the second statistics data to the SMF to be forwarded to the PCF. The PCF may determine to adjust the UL PDB and the DL PDB based on the second statistics data and the RT latency requirement. The UL PDB may be decreased to 8 ms (top right-hand side). The DL PDB may be decreased to 12 ms (bottom right-hand side).

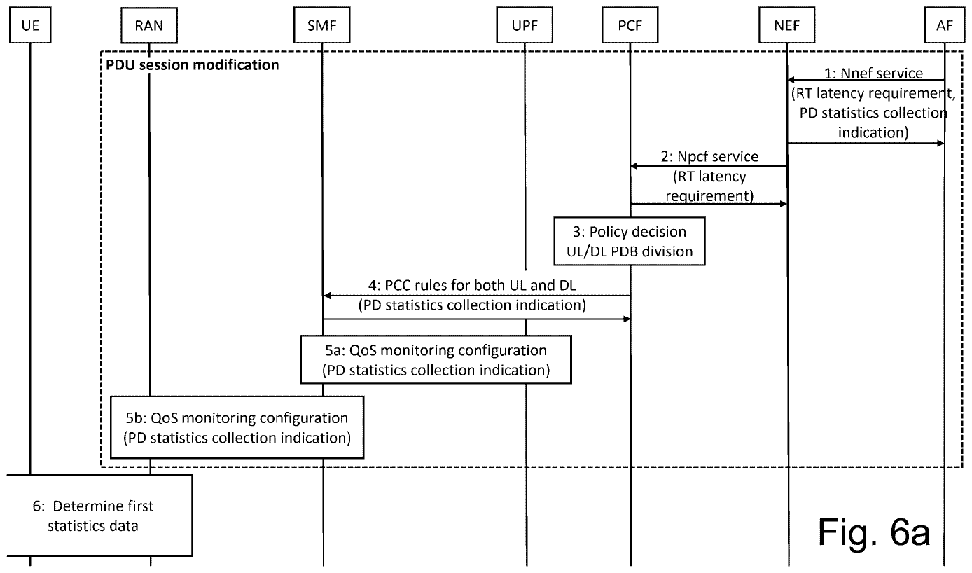

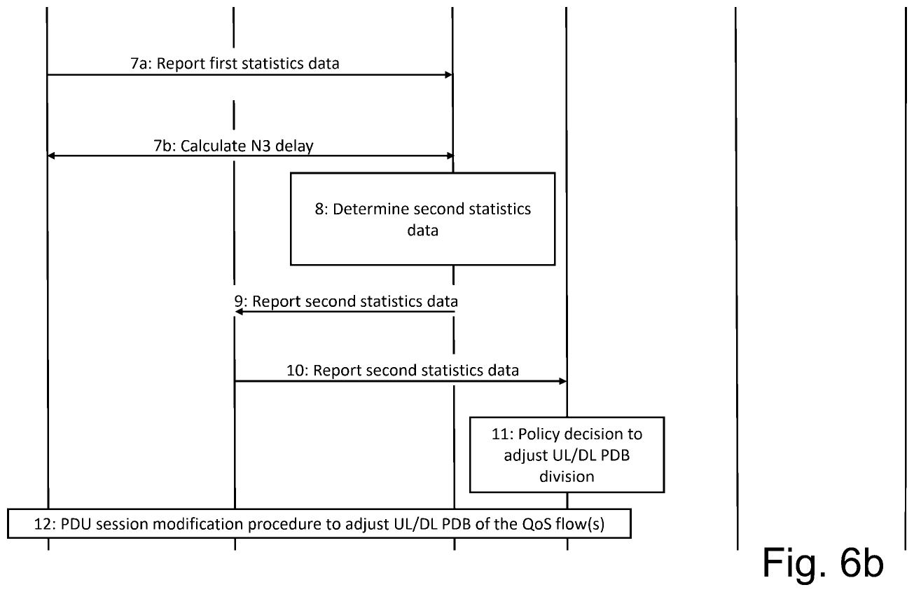

FIG. 6 shows a signaling diagram of a process for adjusting both an UL PDB and a DL PDB.

In step 1, the AF may send, to the NEF, a RT latency requirement for a service data flow. The AF may subscribe to the service data flow QoS monitoring information. The AF may send, to the NEF, a request to collect statistics data from the UPF.

In step 2, the NEF may send, to the PCF, the RT latency requirement for the service data flow. The NEF may send, to the PCF, the request to collect statistics data from the UPF.

In step 3, the PCF may set the UL PDB and the DL PDB for a QoS flow associated with the service data flow based on the RT latency requirement.

The PCF may decide that an UL packet delay and a DL packet delay or a RT latency should be tracked. The decision may be based on inputs from the AF or based on a local configured policy.

If the PCF decides that an UL packet delay and a DL packet delay should be tracked, the PCF may decide that first statistics data for a RAN part of an UL packet delay and a RAN part of a DL packet delay for the QoS flow should be determined by the RAN. The decision may be based on inputs from the AF or based on a local configured policy.

In step 4, the PCF may send, to the SMF, an indication indicating that statistics data should be determined. The indication may be part of policy and charging control (PCC) rules.

The PCF may send, to the SMF, an indication indicating at least one parameter to determine the statistics data. The at least one parameter may comprise an indication of the QoS monitoring reporting frequency, an indication of the statistics window or whether the statistics data to be determined is the first statistics data for a RAN part of an UL packet delay and a RAN part of a DL packet delay for the QoS flow or statistics data for a RAN part of a RT latency. The indication may be part of the PCC rules.

In step 5a, the SMF may trigger a QoS monitoring procedure with the RAN. The SMF may send, to the RAN, the indication indicating that statistics data should be determined. The SMF may send, to the RAN, the indication indicating at least one parameter to determine the statistics data.

In step 5b, the SMF may trigger a QoS monitoring procedure with the UPF. The SMF may send, to the UPF, an indication indicating that second statistics data for an UL packet delay between a UE and the UPF and a DL packet delay between the UPF and a UE should be determined.

In step 6, the RAN may measure the RAN part of an UL packet delay and the RAN part of a DL packet delay during the statistics window. The RAN may determine the first statistics data for the RAN part of an UL packet delay and the RAN part of a DL packet delay based on the measurements of the RAN part of an UL packet delay and a RAN part of a DL packet delay during the statistics window. The first statistics data may comprise a distribution for the RAN part of an UL packet delay and the RAN part of a DL packet delay. The first statistics data may comprise at least one of an average or a standard deviation.

In step 7a, the RAN may report the measurements of the RAN part of an UL packet delay and a RAN part of a DL packet delay to the UPF at the QoS monitoring reporting frequency.

The RAN may report the first statistics data to the UPF.

In step 7b, the UPF may calculate the 5GC part of an UL packet delay and the 5GC part of a DL packet delay. The 5GC part of an UL packet delay and the 5GC part of a DL packet delay may be incurred by the N3 interface between the RAN and the UPF. In step 8, the UPF may use the first statistics data and the calculated 5GC part of an UL packet delay or the 5GC part of a DL packet delay to determine second statistics data. The second statistics data may comprise a distribution for the sum of the RAN part and the 5GC part of an UL packet delay between a UE and the UPF or the sum of the RAN part and the 5GC part of a DL packet delay between the UPF and a UE. The second statistics data may comprise at least one of an average or a standard deviation.

In step 9, the UPF may send, to the SMF, the second statistics data.

In step 10, the SMF may send, to the PCF, the second statistics data.

In step 11, the PCF may determine to adjust the UL PDB and the DL PDB based on the second statistics data and the RT latency requirement.

In step 12, the PCF may trigger a PDU session modification procedure to adjust the UL PDB and the DL PDB for the associated QoS flow based on the determined adjusted UL PDB and the adjusted DL PDB.

It will be understood that, although in the above examples both the UL PDB and a DL PDB are adjusted, only one of the UL PDB and a DL PDB may be adjusted in a variation of these examples.

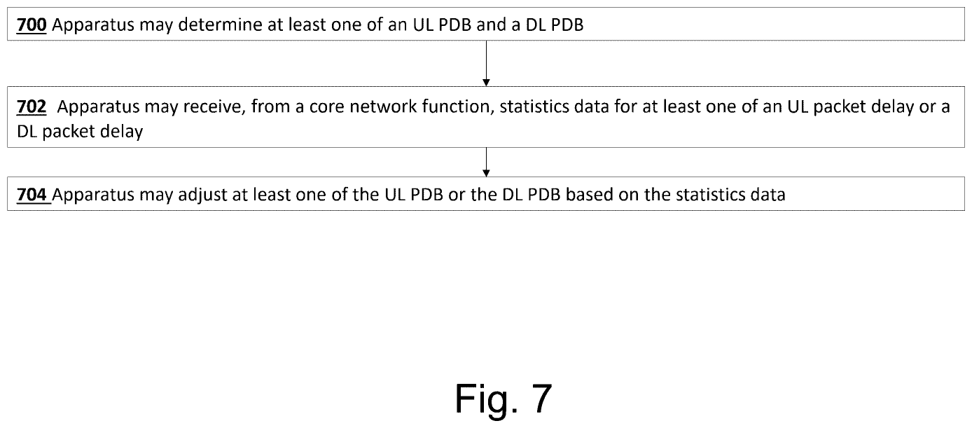

FIG. 7 shows a block diagram of a method for adjusting at least one of an UL PDB or a DL PDB performed by an apparatus, for example a PCF.

In step 702, the apparatus may determine at least one of an UL PDB and a DL PDB. In step 704, the apparatus may receive, from a CN function, statistics data for at least one of an UL packet delay or a DL packet delay.

In step 706, the apparatus may adjust at least one of the UL PDB or the DL PDB based on the statistics data.

The statistics data for at least one of an UL packet delay or a DL packet delay may comprise a distribution for at least one of an UL packet delay or a DL packet delay.

The statistics data for at least one of an UL packet delay or a DL packet delay may comprise at least one of an average or a standard deviation.

The apparatus may adjust at least one of the UL PDB or the DL PDB based on a round trip latency requirement.

The statistics data and the round trip latency requirement may be specific for a certain quality of service flow.

The apparatus may adjust at least one of the UL PDB or the DL PDB so that the UL packet delay limited by the UL PDB plus the DL packet delay limited by the DL PDB is lower than or equal to the round trip latency requirement.

The apparatus may send, to a CN function, an indication indicating to determine statistics data.

The apparatus may send, to a CN function, an indication indicating at least one parameter to determine the statistics data.

The at least one parameter may comprise an indication of a first time interval, an indication of a second time interval or an indication indicating the statistics data to be determined.

The apparatus may send, to the CN function, at least one of the indication indicating to determine statistics data or the indication indicating at least one parameter to determine the statistics data in response to a request, from another CN function, to obtain statistics data.

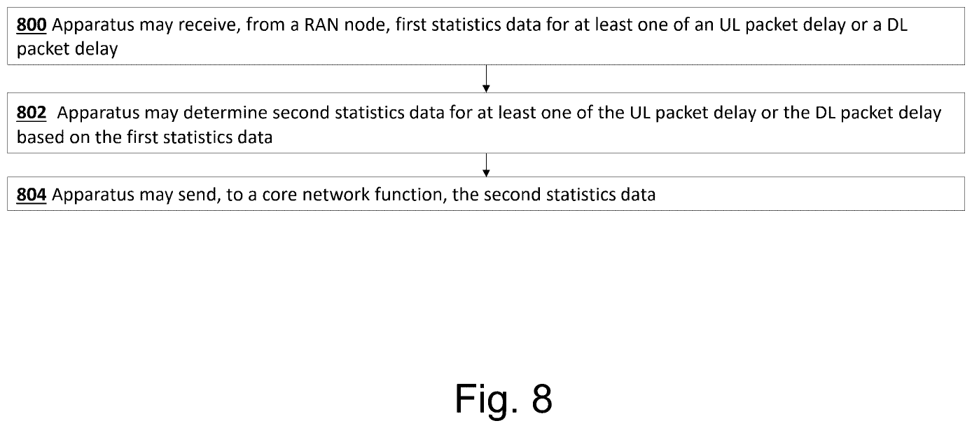

FIG. 8 shows a block diagram of a method for adjusting at least one of an UL PDB or a DL PDB performed by an apparatus, for example a UPF.

In step 800, the apparatus may receive, from a RAN node, first statistics data for at least one of an UL packet delay or a DL packet delay.

In step 802, the apparatus may determine second statistics data for at least one of the UL packet delay or the DL packet delay based on the first statistics data.

In step 804, the apparatus may send, to a CN function, the second statistics data.

The first statistics data may comprise a distribution for at least one of a radio access network part of the UL packet delay or a radio access network part of the DL packet delay.

The first statistics data may comprise at least one of an average and a standard deviation.

The apparatus may determine at least one of a CN part of the UL packet delay and a CN part of the DL packet delay. The apparatus may determine the second statistics data based on at least one of the CN part of the UL packet delay or the CN part of the DL packet delay.

The second statistics data may comprise a distribution for a sum of the RAN part and the CN part of the UL packet delay or a sum of the RAN part and the CN part of the DL packet delay.

The second statistics data may comprise at least one of an average and a standard deviation.

The second statistics data is determined at a first time interval (i.e. statistics window). The second statistics data is based on measurements reported at a second time interval (i.e. QoS monitoring reporting frequency). The measurement is reported by the RAN and includes first statistics data.

The second time interval is different from the first time interval.

Determining the second statistics data may comprise storing the measurements reported at the second time interval, including the first statistics data, and calculating the second statistics data based on the first statistics data. Taking the FIG. 4 as an example to show the schematic representation of a QoS reporting frequency and a statistics window from the UPF perspective.

In an example, the apparatus may receive measurements reported by the RAN node per 2 ms, including the first statistics data. The apparatus may store the measurements and may calculate the second statistics data based on the first statistics data per 4 ms. The apparatus may send the second statistics data to the SMF per 4 ms.

In another example, the apparatus may receive measurements reported by the RAN node per 2 ms, including the first statistics data. The apparatus may calculate the second statistics data based on the first statistics data immediately and may store the second statistics data. The apparatus may further calculate the second statistics data based on the stored second statistics data per 4 ms. The apparatus may send the second statistics data to the SMF per 2 ms.

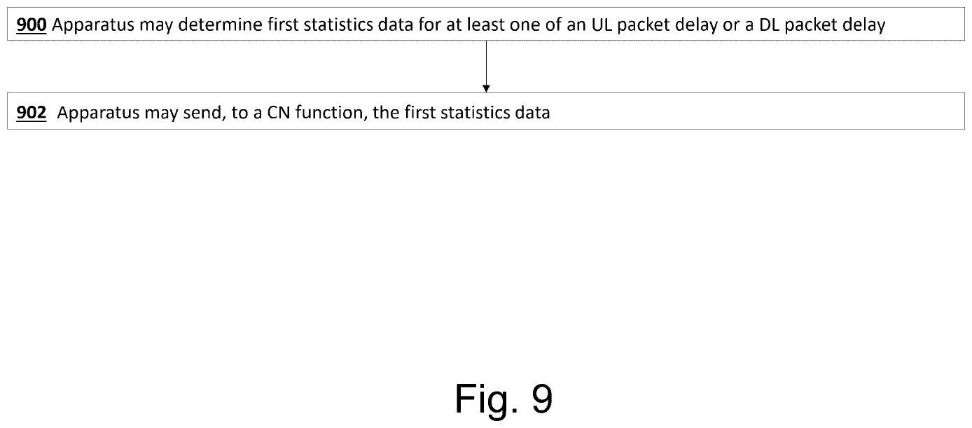

Other examples are possible.
FIG. 9 shows a block diagram of a method for adjusting at least one of an UL PDB or a DL PDB performed by an apparatus, for example a RAN node.

In step 900, the apparatus may determine first statistics data for at least one of an UL packet delay or a DL packet delay.

In step 904, the apparatus may send, to a CN function, the first statistics data.

The apparatus may receive, from a CN function, an indication indicating to determine statistics data.

The apparatus may receive, from a CN function, an indication indicating at least one parameter to determine the statistics data.

The first statistics data may be determined at a first time interval (i.e. statistics window).

The first statistics data may be determined by the apparatus based on measurements at a second time interval (i.e. QoS monitoring reporting frequency).

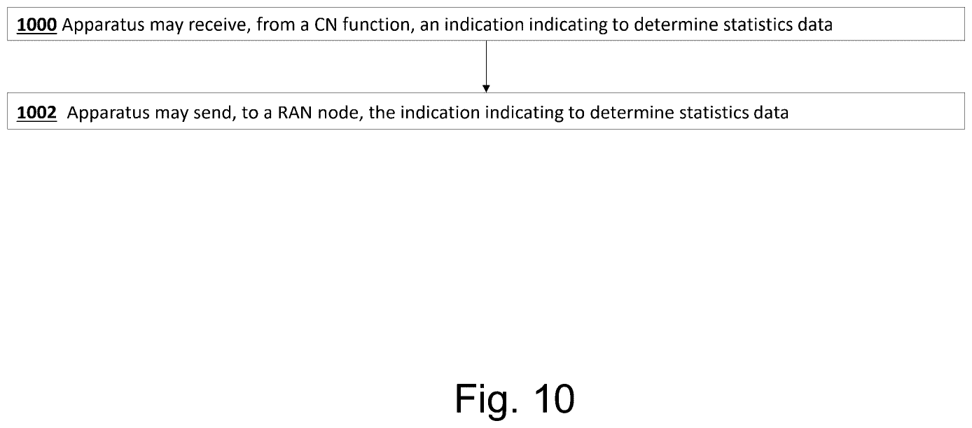

FIG. 10 shows a block diagram of a method for adjusting at least one of an uplink packet delay budget or a downlink packet delay budget performed by an apparatus, for example a SMF.

In step 1000, the apparatus may receive, from a CN function, an indication indicating to determine statistics data.

In step 1002, the apparatus may send, to a RAN node, the indication indicating to determine statistics data.

The apparatus may receive, from the CN function, an indication indicating at least one parameter to determine the statistics data. The apparatus may send, to the RAN node, the indication indicating at least one parameter to determine the statistics data. The apparatus may receive, from the CN function, the statistics data. The apparatus may send, to another CN function, the statistics data.

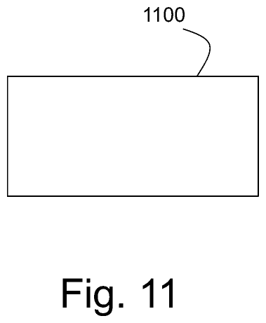

FIG. 11 shows a schematic representation of non-volatile memory media 1100 storing instructions and/or parameters which when executed by a processor allow the processor to perform one or more of the steps of the methods of FIGS. 7 to 10. It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 7 to 10, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising at least one processor and at least one memory storing instructions that, when executed by the at least one processor, cause the apparatus at least to:
determine at least one of an uplink packet delay budget and a downlink packet delay budget;
receive, from a core network function, statistics data for at least one of an uplink packet delay or a downlink packet delay; and
adjust at least one of the uplink packet delay budget or the downlink packet delay budget based on the statistics data.

2. The apparatus of claim 1, wherein the statistics data for at least one of an uplink packet delay or a downlink packet delay comprises a distribution for at least one of an uplink packet delay or a downlink packet delay.

3. The apparatus of claim 2, wherein the statistics data for at least one of an uplink packet delay or a downlink packet delay comprises at least one of an average or a standard deviation.

4. The apparatus of claim 1, wherein the at least one processor and at least one memory store instructions that, when executed by the at least one processor, cause the apparatus at least to:
adjust at least one of the uplink packet delay budget or the downlink packet delay budget based on a round trip latency requirement.

5. The apparatus of claim 4, wherein the statistics data and the round trip latency requirement are specific for a certain quality of service flow.

6. The apparatus of claim 4, wherein the at least one processor and at least one memory store instructions that, when executed by the at least one processor, cause the apparatus at least to:
adjust at least one of the uplink packet delay budget or the downlink packet delay budget so that the uplink packet delay limited by the uplink packet delay budget plus the downlink packet delay limited by the downlink packet delay budget is lower than or equal to the round trip latency requirement.

7. The apparatus of claim 1, wherein the at least one processor and at least one memory store instructions that, when executed by the at least one processor, cause the apparatus at least to:
send, to a core network function, an indication indicating to determine statistics data.

8. The apparatus of claim 7, wherein the at least one processor and at least one memory store instructions that, when executed by the at least one processor, cause the apparatus at least to:
send, to a core network function, an indication indicating at least one parameter to determine the statistics data.

9-10. (canceled)

11. An apparatus comprising at least one processor and at least one memory storing instructions that, when executed by the at least one processor, cause the apparatus at least to:
receive, from a radio access network node, first statistics data for at least one of an uplink packet delay or a downlink packet delay;
determine second statistics data for at least one of the uplink packet delay or the downlink packet delay based on the first statistics data; and
send, to a core network function, the second statistics data.

12. The apparatus of claim 11, wherein the first statistics data comprises a distribution for at least one of a radio access network part of the uplink packet delay or a radio access network part of the downlink packet delay.

13. The apparatus of claim 12, wherein the first statistics data comprises at least one of an average and a standard deviation.

14. The apparatus of claim 11, wherein the at least one processor and at least one memory store instructions that, when executed by the at least one processor, cause the apparatus at least to:
determine at least one of a core network part of the uplink packet delay and a core network part of the downlink packet delay; and
determine the second statistics data based on at least one of the core network part of the uplink packet delay or the core network part of the downlink packet delay.

15. The apparatus of claim 14, wherein the second statistics data comprises a distribution for a sum of the radio access network part and the core network part of the uplink packet delay or a sum of the radio access network part and the core network part of the downlink packet delay.

16. The apparatus of claim 15, wherein the second statistics data comprises at least one of an average and a standard deviation.

17. The apparatus of claim 11, wherein the second statistics data is determined at a first time interval.

18-19. (canceled)

20. An apparatus comprising at least one processor and at least one memory storing instructions that, when executed by the at least one processor, cause the apparatus at least to:
determine first statistics data for at least one of an uplink packet delay or a downlink packet delay; and
send, to a core network function, the first statistics data.

21. The apparatus of claim 20, wherein the at least one processor and at least one memory store instructions that, when executed by the at least one processor, cause the apparatus at least to:
receive, from a core network function, an indication indicating to determine statistics data.

22. The apparatus of claim 20 or claim 21, wherein the at least one processor and at least one memory store instructions that, when executed by the at least one processor, cause the apparatus at least to:
receive, from a core network function, an indication indicating at least one parameter to determine the statistics data.

23. The apparatus of claim 20, wherein the first statistics data is determined at a first time interval.

24. The apparatus of claim 20, wherein the first statistics data is based on measurements at a second time interval.

25-32. (canceled)
